(19) United States
(12) Patent Application Publication
(10) Pub. No.: US 2002/0021407 A1
(43) Pub. Date: Feb. 21, 2002

(54) Eye-wear video game

(76) Inventor: Scott Elliott, Federal Way, WA (US)

Correspondence Address: NIXON & VANDERHYE P.C., 8th Floor, 1100 North Glebe Road, Arlington, VA, 22201, US

(21) Appl. No.: 09/917,809

(22) Filed: Jul. 31, 2001

Related U.S. Application Data
(60) Provisional application No. 60/222,297, filed on Aug. 1, 2000.

(51) Int. Cl. G02C 1/00

(52) U.S. Cl. 351/158

(57) ABSTRACT

A gesture-controlled video game is attachable to the frame of a pair of eyeglasses. A housing contains a miniaturized control unit and display, which can be attached to the user's eyeglasses without obstructing the user's vision through the eyeglasses. A control unit includes a memory that stores a game program and a processor that executes the game program. A display is coupled with the control unit. The image generated by the display is transmitted to an eyepiece disposed in a user's path of vision via a fiber optic bundle. A motion sensor secured to the housing detects linear and angular motion of the housing and communicates a corresponding motion signal to the control unit. Execution of the game program by the processor is thus performed according to a user's head gestures.

### CROSS-REFERENCES TO RELATED APPLICATIONS

This application claims the benefit of U.S. Provisional Patent Application Ser. No. 60/222,297, filed Aug. 1, 2000, the entire content of which is herein incorporated by reference.

### STATEMENT REGARDING FEDERALLY SPONSORED RESEARCH OR DEVELOPMENT

(NOT APPLICABLE)

### BACKGROUND OF THE INVENTION

The present invention relates video games and, more particularly, to a low-cost compact video game that is attachable to the frame of a pair of eyeglasses.

Eyeglass mounted display devices with static applications such as for displaying a stopwatch for athletes during training or races are known. Examples of these devices are described in, for example, U.S. Pat. No. 4,796,987, U.S. Pat. No. 5,266,977 and U.S. Pat. No. 5,585,871, the disclosures of which are hereby incorporated by reference. Such a product with a stopwatch application is available from Infoeye Technologies, Inc. of Santa Barbara, Calif. These designs, however, use only buttons for user input.

In a game application, it would be desirable to enable the use of head gestures for controlling game play, thereby expanding the human-machine interface. Moreover, humans are used to controlling their point of view as well as gesturing to others using head motions.

### SUMMARY OF THE INVENTION

The device according to the present invention uses a simple segmented display and a fiber optic bundle to view the game. The unit is small enough to be powered by a watch battery and can be clipped to the frame of a pair of eyeglasses. An exemplary game used to facilitate the explanation of the device according to the present invention could be Tetris. The device includes a motion sensor such that game play is controlled using head motions or gestures to activate simple tile switches. For example, nodding the head up rotates the game piece, and nodding the head down drops the game piece. Nodding left or right moves the game piece left or right. One or more buttons may be provided on the unit for power and select/start. Of course, other games could be implemented into the system according to the present invention as would be apparent to those of ordinary skill in the art, and the invention is not meant to be limited to a particular described example.

In an exemplary embodiment of the invention, a gesture-controlled video game is attachable to an eye-wear frame. The game includes a control unit with a memory that stores a game program and a processor that executes the game program. A display is coupled with the control unit, and the control unit drives the display according to the game program executed by the processor. A display transmitting unit includes a fiber optic bundle coupled with the display and an eyepiece, wherein an image on the display is transmitted to the eyepiece via the fiber optic bundle. The housing contains at least the control unit and the display and has an attaching device that is attachable to the eye-wear frame. A motion sensor is secured to the housing and operatively coupled with the control unit for detecting linear and angular motion of the housing and for communicating a corresponding motion signal to the control unit. In this context, the processor executes the game program according to the motion signal received from the motion sensor. Preferably, the motion sensor detects eight head gestures being turn left, turn right, tilt left, tilt right, up, down, circle clockwise and circle counter-clockwise.

In the display, the device may include an objective lens disposed between the display and the fiber optic bundle and an eye lens disposed between the fiber optic bundle and the eyepiece. At least one of these lenses may be adjustable for custom focusing. Preferably, the image is displayed at an infinite depth.

The processor may include an application specific integrated circuit formed on a single silicon chip. In one arrangement, the fiber optic bundle includes a plastic bundle formed over a glass bundle, and in another arrangement, the fiber optic bundle includes a glass bundle. A light tube may be provided for housing the fiber optic bundle. Additionally, a back light may be disposed adjacent the display. In one arrangement, the back light is a chemical luminescent module, or alternatively, the back light includes a light-emitting diode.

In another exemplary embodiment of the invention, a gesture-controlled video game includes a control unit including a memory that stores a game program and a processor that executes the game program. The control unit drives a display according to the game program executed by the processor. A housing contains the control unit and the display and includes an attaching device that is attachable to a frame of a pair of eyeglasses. A display transmitting unit includes a fiber optic bundle coupled with the display and an eyepiece, wherein an image on the display is transmitted to the eyepiece via the fiber optic bundle, and wherein the eyepiece is sized to minimize viewing obstruction through the eyeglasses. Execution of the game program by the processor is performed according to a user's head gestures. In one preferred embodiment, the display is a liquid crystal display having a display area less than 1113 in .

### BRIEF DESCRIPTION OF THE DRAWINGS

These and other aspects and advantages of the present invention will be described in detail with reference to the accompanying drawings, in which:

FIG. 1 is a perspective view of the device according to the invention attached to a frame of a pair of eyeglasses;

FIG. 2 is a schematic block diagram of the device components; and

FIG. 3 illustrates exemplary head gestures that can be used to control the game in the device according to the present invention.

### DETAILED DESCRIPTION OF PREFERRED EMBODIMENTS

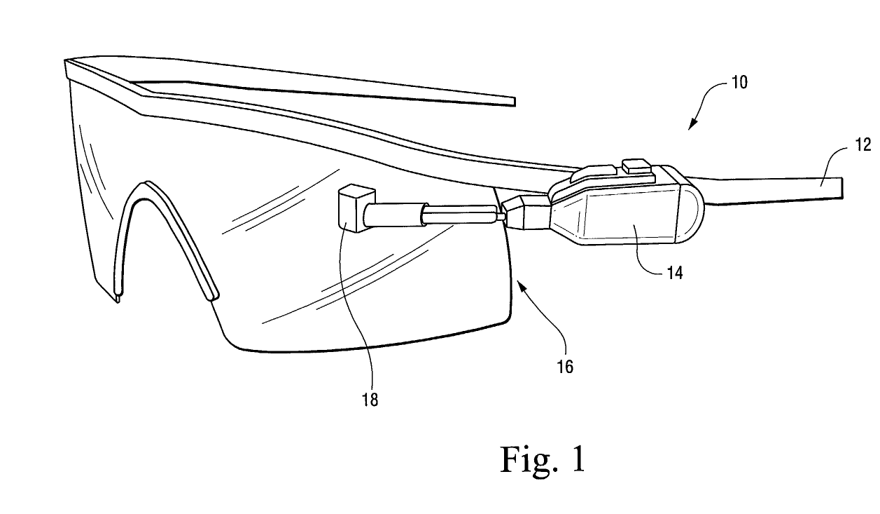

With reference to FIG. 1, the device 10 according to the present invention is shown attached to the frame 12 of a pair of eyeglasses. The device generally includes a housing 14 containing electrical components of the device and a display transmitting unit 16 that houses components for transmitting the display to an eyepiece 18 disposed in a user's line of vision as shown in FIG. 1. One or more buttons may be provided on the housing 14 for power and select/start. As described below, the image is preferably transmitted from a display in the housing 14 to the eyepiece 18 via a fiber optic bundle contained with the display transmitting unit 16. As a consequence, the eyepiece 18 can be made very small to thereby minimize viewing obstruction through the eyeglasses.

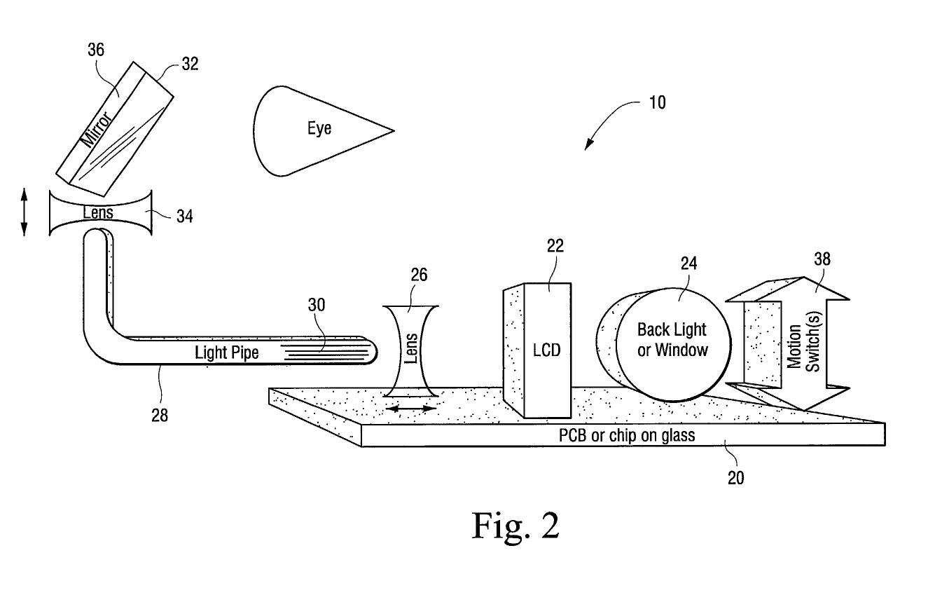

The components of the device 10 will be described with reference to the schematic block diagram shown in FIG. 2.

In the device available from Infoeye Technologies, Inc., the optics configuration allows for the same device to be mounted to either the left or right side of a user's head, and the module is easily aligned for optimum viewing while minimizing viewing obstruction. The lightweight module is completely self-contained and does not require additional cable or power supplies. A control unit 20 is preferably a simple processor of single chip ASIC (application specific integrated circuit) design including an 8 bit CPU or hard-coded logic, RAM, program ROM, power management (e.g., batteries) and display driver. An external oscillator (not shown) may also be required. A display 22 such as a liquid crystal display is coupled with the control unit 20. The control unit 20 drives the display 22 according to the game program executed by the system processor. The display 22 preferably has a display area less than 1/13 in². This small size reduces the size of the device and lowers power requirements. While the LCD is not necessarily a high resolution matrix display, it is a formed segment addressable display that will provide a very high quality display. The housing 14 may include one or more transparent portions to allow light in for the display. An optional back light 24 may be provided for 546074 the display including a conventional LED (light-emitting diode) or a chemical luminescent module.

An objective lens 26 is disposed adjacent the display 22. A light pipe 28 houses a fiber optic bundle 30 that serves to transmit the image on the display 22 to an eyepiece 32. By using the fiber optic bundle 30, the need for complex optics is eliminated and results in a sleeker design. A plastic bundle may be used over a glass bundle to reduce cost and weight. An optional glass bundle could also be used for improved brightness. An eye lens 34 is disposed between the light pipe 28 and fiber optic bundle 30 and the eyepiece 32. At least one of the objective lens 26 or the eye lens 34 is adjustable to effect custom focusing. The eyepiece 32 includes a mirror 36 that reflects the image toward a user's line of vision. The basic optics can be constructed using an off-the-shelf device that uses a 3½, 7 segment time-of-day display.

The device may also include a wired or wireless remote control. The remote control can include game control functions that are not suitable for head gesture control. Any appropriate structure for wired/wireless control can be used.

At least one motion sensor 38 is secured to the housing and is operatively coupled with the control unit 20. The motion sensor 38 detects linear and angular motion of the housing 14 and communicates a corresponding motion signal to the control unit 20. There exist many types of sensors to measure linear and angular motion. The sensors may be simple switches or analog force sensors. One least expensive alternative is a moving mass that closes a switch contact. An analog accelerometer could also be used and has the advantage of being both programmable as a threshold in a switch or providing ratiometric input to the game. A force activated multi-step switch could also be used. Dampening can be used to reduce ringing of the transducer mass. Transducer technology could be either macro-mechanical or micro-machined base. Examples of offthe-shelf low cost tilt switches include SWI-108 from Switronic and the 6-position Sw6 from AOSI (aositilt.com). Of course, more exotic methods can be used if needed, and the invention is not necessarily meant to be limited to one particular motion sensor. For example, a flux gate compass could be used for absolute and relative bearing measurement.

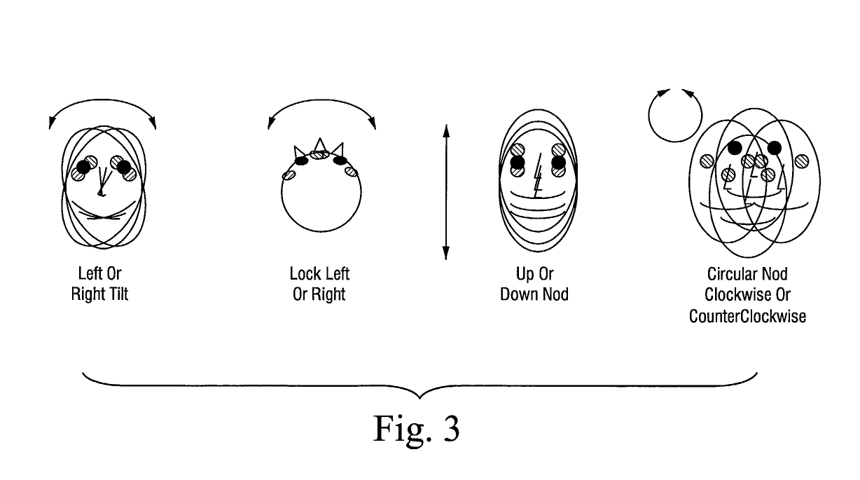

The motion sensor 38 can be used to detect numerous head gestures. Referring to FIG. 3, eight exemplary head gestures for use in controlling execution of the video game are shown. These head gestures include turn left, turn right, tilt left, tilt right, up, down, circle clockwise and circle counter-clockwise. In the example application using the Tetris game, left and right head gestures (either turning or tilting) can be used to move falling pieces left and right, respectively, while up gestures can be used to rotate the pieces, and down gestures can be used to cause the pieces to fall more rapidly. Still additional gestures can be made by making compound motions across multiple planes or bi-directional within a single plane.

More specific device specifications are described in connection with the device available from Infoeye Technologies, Inc. The following target specifications are exemplary.

Mechanical

Length Body 38 mm, 76 mm overall

Width: 12 mm

Height: 15 mm

Weight: 5 grams

Features

Back light: Replaceable glow plug for continuous illumination

Water immersion: 100 foot water resistant

Power

Battery: Single silver-oxide, 1.5 volt

Life: Normal use, 1 year est.

Replace: User replaceable

Optics

LCD: Transmissive 6×8 mm, 186 segment display

Image Conduit (Specs for Glass Fiber, would change for Plastic Fiber)

Fiber bundle, 3 mm dia.

44-lp/mm minimum

50 k fibers minimum

Refractive index 1.58

Transmission 45% minimum @ 400 to 750 nm

Numerical aperture, 0.55 minimum

Eye lens: Plano-convex or aspherical

Objective lens

Magnification: 16×

Focal distance: 250 mm minimum

Accessories

Night illumination: Chemical luminescent module, LED

Mounting Adapters: Adapters to aid mounting with unusual eye glasses designs.

With the game system according to the present invention, a low cost and unique game implementation can be conveniently attached to a user's eyeglasses enabling the use of head gestures to control game play. Game play can be demonstrated on a PC by emulating the segmented display and building a tilt sensor unit to control the game. The compact nature of the device enables ready attachment to the frame of a pair of eyeglasses while minimizing viewing obstruction through the eyeglasses.

While the invention has been described in connection with what is presently considered to be the most practical and preferred embodiments, it is to be understood that the invention is not to be limited to the disclosed embodiments, but on the contrary, is intended to cover various modifications and equivalent arrangements included within the spirit and scope of the appended claims.

1. A gesture-controlled video game attachable to an eye-wear frame, the video game comprising:
a control unit including a memory that stores a game program and a processor that executes the game program;
a display coupled with the control unit, the control unit driving the display according to the game program executed by the processor;
a display transmitting unit including a fiber optic bundle coupled with the display and an eyepiece, wherein an image on the display is transmitted to the eyepiece via the fiber optic bundle;
a housing containing at least the control unit and the display, the housing including an attaching device that is attachable to the eye-wear frame; and
a motion sensor secured to the housing and operatively coupled with the control unit, the motion sensor detecting linear and angular motion of the housing and communicating a corresponding motion signal to the control unit.

2. A gesture-controlled video game according to claim 1, wherein the processor executes the game program according to the motion signal received from the motion sensor.

3. A gesture-controlled video game according to claim 2, wherein the motion sensor detects eight head gestures being turn left, turn right, tilt left, tilt right, up, down, circle clockwise and circle counter-clockwise.

4. A gesture-controlled video game according to claim 1, further comprising an objective lens disposed between the display and the fiber optic bundle and a eye lens disposed between the fiber optic bundle and the eyepiece.

5. A gesture-controlled video game according to claim 4, wherein at least one of the objective lens and the eye lens is adjustable for custom focusing.

6. A gesture-controlled video game according to claim 4, wherein the image is displayed at an infinite depth.

7. A gesture-controlled video game according to claim 1, wherein the processor comprises an application specific integrated circuit formed on a single silicon chip.

8. A gesture-controlled video game according to claim 1, wherein the fiber optic bundle comprises a plastic bundle formed over a glass bundle.

9. A gesture-controlled video game according to claim 1, wherein the fiber optic bundle comprises a glass bundle.

10. A gesture-controlled video game according to claim 1, further comprising a light tube housing the fiber optic bundle.

11. A gesture-controlled video game according to claim 1, further comprising a back light disposed adjacent the display.

12. A gesture-controlled video game according to claim 11, wherein the back light comprises a chemical luminescent module.

13. A gesture-controlled video game according to claim 11, wherein the back light comprises a light-emitting diode.

14. A gesture-controlled video game comprising:
a control unit including a memory that stores a game program and a processor that executes the game program, the control unit driving a display according to the game program executed by the processor;
a housing containing the control unit and the display and including an attaching device that is attachable to a frame of a pair of eyeglasses; and
a display transmitting unit including a fiber optic bundle coupled with the display and an eyepiece, wherein an image on the display is transmitted to the eyepiece via the fiber optic bundle, and wherein the eyepiece is sized to minimize viewing obstruction through the eyeglasses,
wherein execution of the game program by the processor is performed according to a user's head gestures.

15. A gesture-controlled video game according to claim 14, further comprising a motion sensor secured to the housing and operatively coupled with the control unit, the motion sensor detecting linear and angular motion of the housing and communicating a corresponding motion signal to the control unit.

16. A gesture-controlled video game according to claim 15, wherein the motion sensor detects eight head gestures being turn left, turn right, tilt left, tilt right, up, down, circle clockwise and circle counter-clockwise.

17. A gesture-controlled video game according to claim 14, wherein the display is a liquid crystal display having a display area less than 1/13 in².
